(19) United States
(12) Patent Application Publication
(10) Pub. No.: US 2009/0252908 A1
(43) Pub. Date: Oct. 8, 2009

(54) VEHICLE COMPONENT WITH A HYBRID STRUCTURE

(75) Inventors: Paul Angenheister, Tonisvorst (DE); Thomas Beer, Grefrath (DE); Alfred Mai, Huckeswagen (DE); Klaus Kierspel, Rosrath (DE); Norberto Silva, Essen (DE); Jochen Zimmermann, Wuppertal (DE); Vikto Arbanas, Baden (CH); Michael Maag, Gams (CH); Carsten Mannek, Feldkirch (AT); Max Oertle, Mauren (LI); Christian Dornscheidt, Dusseldorf (DE); Matthias Hein, Gelsenkirchen (DE); Martin Hinz, Issum (DE); Mark Hirt, Bochum (DE); Peter Seyfried, Dortmund (DE); Markus Zornack, Dortmund (DE)

Correspondence Address: Johnson Controls, Inc.;c/o Fletcher Yoder PC, P.O. Box 692289, Houston, TX, 77269, US

(73) Assignee: Johnson Control Technology Company, Holland, MI (US)

(21) Appl. No.: 12/398,115

(22) Filed: Mar. 4, 2009

(30) Foreign Application Priority Data
Sep. 5, 2006 (DE) 10 2006 042 045.4
Sep. 5, 2007 (EP) PCT/EP2007/007745

(51) Int. Cl. B32B 15/08; B32B 37/00; B29C 45/14; B21D 53/88

(52) U.S. Cl. 428/35.8; 264/271.1; 156/60; 29/897.2

(57) ABSTRACT

A vehicle component is provided for a motor vehicle, such as an interior fitting part, and particularly for a component of a vehicle cockpit. The component has a hybrid structure that includes a metal part and a polymeric component. The metal part is surrounded by the polymeric component in a first region. The metal part has a second region which is free from the polymeric component. The second region is connected to a metal reinforcement. The polymeric component may comprise glass fibers. The first region of the metal part may be frame-shaped, and the second region may be arranged in a central region of the metal part. The metal reinforcement may be permanently secured to the metal part, such as by welding, or by an interference or form fit. The metal part may be surrounded by the polymeric component by injection molding and/or shaping.

### CROSS REFERENCE TO RELATED APPLICATIONS

This application claims priority from and the benefit of PCT Application No. PCT/EP2007/007745, filed on Sep. 5, 2007; and German Patent No. DE 10 2006 042 045.4, filed on Sep. 5, 2006; both entitled “Vehicle Component with a Hybrid Structure”, which are herein incorporated by reference.

### BACKGROUND

The present invention relates to a vehicle component with a hybrid structure, wherein the hybrid structure has at least one metal part and a polymeric component, wherein the metal part is surrounded by the polymeric component in a first region, and wherein the metal part has a second region which is free from the polymeric component and is connected to a metal reinforcement. The present invention also relates to a method for producing a vehicle component.

Plastic/metal composite bodies, hereinafter also referred to as hybrid structures, are employed in the automotive sector, particularly for parts with large surface areas, and are known for example from DE 44 37 773 and EP 0 721 831 B1. However, these hybrid structures often exhibit insufficient mechanical strength. Furthermore, DE 10 2005 001 367 A1 discloses a metal-reinforced hybrid structure which can be employed, for example, as a reinforcement component in a vehicle. A disadvantage of this hybrid structure is that it is not intended to be integrated in an interior fitting part of the vehicle; instead, a supporting component of the vehicle is merely structurally reinforced.

### SUMMARY

An object of the invention is therefore to provide a vehicle component with a hybrid structure which does not exhibit the disadvantages of the prior art.

This object is achieved by means of a vehicle component with a hybrid structure, wherein the hybrid structure has at least one metal part and one polymeric component, wherein the metal part is surrounded by the polymeric component in a first region, wherein the metal part has a second region which is free from the polymeric component and is connected to a metal reinforcement, and wherein the polymeric component is part of an interior fitting part of a vehicle, in particular a cockpit. According to the invention, this advantageously makes it possible to avoid having to carry out separate development of the interior fitting part and a supporting component for the interior fitting part or for the vehicle structure; instead, it is possible to design just the interior fitting part (with the supporting component) to be stable such that it withstands the load requirements. This is primarily advantageous since more extensive functionalities can therefore be integrated in the interior fitting part, for example with respect to crash safety or the like.

It is preferred according to the invention if the polymeric component is provided filled with glass fibers or is provided as a thermoplastic polymeric component. According to the invention, this makes it possible for the vehicle component to be produced in a particularly stable manner and also to be implemented in a particularly inexpensive and weight-saving manner.

Furthermore, it is preferred according to the invention if the first region of the metal part has a frame-shaped form or if the second region is arranged in a central region of the metal part. This makes it possible for the vehicle component with a hybrid structure according to the invention to be implemented in a particularly stable and therefore comparatively weight-saving and cost-saving manner.

Furthermore, it is preferred according to the invention if the metal reinforcement is connected to the metal part with a material fit, preferably by welding, particularly preferably by laser welding. This makes it possible to attach the metal reinforcement to the second region in a manner which is particularly simple and protects the polymeric component. Further connection options concern connection by means of an adhesive, connection by means of mechanical connections, such as screws, rivets, clamps or clips, or the like.

Furthermore, it is preferred according to the invention if the polymeric component and the metal part are connected to one another with a non-positive, positive and/or material fit. This makes it possible to integrate the metal part with the polymeric component in a particularly simple and reliable manner, and this gives rise to a particularly stable vehicle component.

Furthermore, it is preferred according to the invention if the metal reinforcement has a profiled cross section. This makes it possible to further increase the stability of the vehicle component and therefore to improve the integrability of the interior fitting part with a structural component of the vehicle.

However, the connection between the metal part and the metal reinforcement is very particularly preferably a material join obtained by adhesive bonding or welding, very particularly preferably by laser welding. Laser welding has the advantage of low heat evolution, and therefore the polymeric component is not damaged or is damaged only slightly.

The present invention also relates to a method for producing the component according to the invention, in which method the metal part and the metal reinforcement are connected to one another with a positive, non-positive and/or material fit, and wherein the metal part and the metal reinforcement are subsequently connected to one another, preferably by welding. This makes it possible to obtain a particularly gentle connection of the metal part to the metal reinforcement. It is preferred if the metal part is surrounded by the polymeric component by injection molding and/or forming. This makes it possible to produce the vehicle component according to the invention in a particularly stable manner.

### DRAWINGS

Exemplary embodiments of the invention are illustrated in the drawing and explained in more detail in the description below.

FIG. 1 schematically shows a method for producing a vehicle component.

FIG. 2 schematically shows a cross-sectional illustration through a vehicle component according to the invention.

FIGS. 3 and 4 schematically show cross-sectional illustrations through the vehicle component according to the invention.

### DETAILED DESCRIPTION

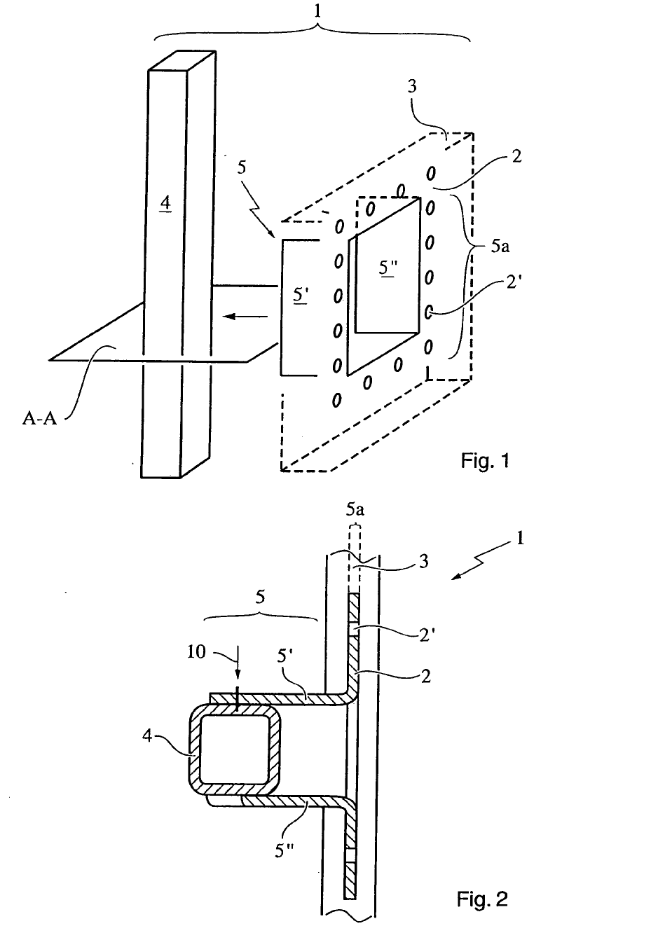

FIG. 1 schematically illustrates a method for producing a vehicle component 1, wherein the vehicle component 1 has a metal part 2 which is provided surrounded by a polymeric component 3 by injection molding. The metal part 2 here has a first region 5a which is provided surrounded substantially completely by the polymeric component 3 by injection molding or enclosed by it. Furthermore, the metal part 2 has a second region 5 which is not enclosed by the polymeric component 3 or is free from the polymeric component 3. According to the invention, the first region 5a is provided, in particular, in the form of a frame-shaped region, whereas the second region 5 is provided in the form of two brackets or protruding legs 5′, 5″, wherein the legs 5′, 5″ are provided protruding from the frame 5a. A metal reinforcement 4 provided, in particular, in the form of a profiled cross member is connected to the legs 5′, 5″ of the metal part 2 in order to reinforce the vehicle component 1, and a particularly stable connection is therefore provided in order to obtain a stable vehicle component 1. FIG. 1 illustrates a sectional plane AA, and a sectional illustration according to this sectional plane is illustrated in FIG. 2.

FIG. 2 illustrates the vehicle component 1 according to the cross-sectional plane AA. The figure shows the polymeric component 3 and the metal part 2 together with its first region 5a and its second region 5, wherein the second region is embodied, in particular, in the form of the protruding legs 5′, 5″. Openings 2′ in the metal part 2 are provided in the first region 5a in order to permit a particularly intimate connection between the metal part 2 in its first region 5a and the polymeric component 3. This provides a non-positive and/or positive and/or material connection between the metal part 2 and the polymeric component 3. The figure also illustrates the location of a weld seam 10 between the metal part 2 and the metal reinforcement 4.

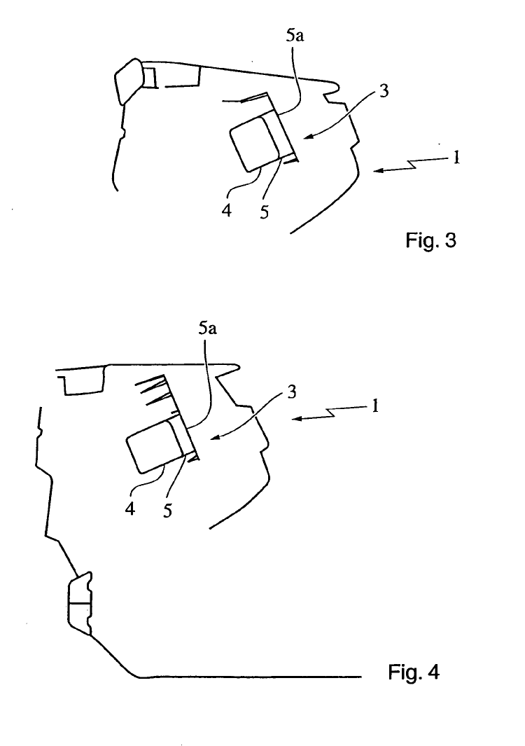

FIGS. 3 and 4 illustrate further cross-sectional illustrations of the vehicle component 1, according to the invention, with the first region 5a of the metal part 2, the second region 5 of the metal part 2, the metal reinforcement 4 and the polymeric component 3.

According to the invention, the metal part 2 is connected to the metal reinforcement 4, for example by means of a welded joint, laser welding being particularly advantageous since it produces relatively little heat during the welding process, which, for example, could affect the polymeric component 3. However, it is also possible to connect the metal part 2 to the metal reinforcement 4 using an adhesive bonding process or using a screwed connection or using a conventional welded joint or using a riveted connection or the like.

According to the invention, it is particularly advantageous if the vehicle component is implemented integrated as an interior fitting part with its structural form which is particularly stable owing to the metal part 2 and the metal reinforcement 4, and there is therefore no need for separate product development for implementing firstly an interior fitting part (i.e. for implementing that side of an interior fitting part which faces the user) and secondly a reinforcement or a structural part for fastening the interior fitting part; instead, these two products are combined with one another in the vehicle component according to the invention.

1. A vehicle component comprising a hybrid structure, wherein the hybrid structure has comprises a metal part and a polymeric component, wherein the metal part being surrounded by the polymeric component in a first region, wherein the metal part has a second region which is free from the polymeric component and is connected to a metal reinforcement, and wherein the polymeric component is part of an interior fitting part of a vehicle.

2. The vehicle component as claimed in claim 1, wherein, the polymeric component comprises glass fibers.

3. The vehicle component as claimed in claim 1, wherein the first region of the metal part is frame-shaped.

4. The vehicle component as claimed in claim 1, wherein the second region is arranged in a central region of the metal part.

5. The vehicle component as claimed in claim 1, wherein the metal reinforcement is permanently secured connected to the metal part.

6. The vehicle component as claimed in claim 1, wherein the polymeric component and the metal part are interference fitted to one another.

7. The vehicle component as claimed in claim 1, wherein the metal reinforcement has a profiled cross section.

8. A method for producing a vehicle component as claimed in claim 1, wherein the metal part and the metal reinforcement are interference fitted to one another.

9. The method as claimed in claim 8, wherein the metal part is surrounded by the polymeric component by injection molding and/or shaping.

10. The method as claimed in claim 8, wherein the metal part and the metal reinforcement are form fitted to one another.

11. The method as claimed in claim 8, wherein the metal part and the metal reinforcement are glued to one another.

12. The method as claimed in claim 8, wherein the metal part and the metal reinforcement are subsequently welded to one another.

13. The method as claimed in claim 10, wherein the metal part and the metal reinforcement are subsequently welded to one another.

14. The method as claimed in claim 11, wherein the metal part and the metal reinforcement are subsequently welded to one another.

15. The vehicle component as claimed in claim 1, wherein the interior fitting part is a vehicle cockpit.

16. The vehicle component as claimed in claim 1, wherein the metal reinforcement secured to the metal part by welding.

17. The vehicle component as claimed in claim 16, wherein the metal reinforcement secured to the metal part by laser welding.

18. The vehicle component as claimed in claim 1, wherein the polymeric component and the metal part are form fitted to one another.

19. The vehicle component as claimed in claim 1, wherein the polymeric component and the metal part are form fitted to one another by welding or gluing.
